(19) United States
(12) Patent Application Publication
(10) Pub. No.: US 2006/0196568 A1
(43) Pub. Date: Sep. 7, 2006

(54) Flexible, compression resistant and highly insulating systems

(76) Inventors: Daniel Louis Leeser, Framingham, MA (US); Christopher Blair, Littleton, CO (US); Brian R. Betty, Nashua, NH (US)

Correspondence Address: ASPEN AEROGELS INC.;IP DEPARTMENT, 30 FORBES ROAD, BLDG. B, NORTHBOROUGH, MA, 01532, US

(21) Appl. No.: 11/329,964

(22) Filed: Jan. 10, 2006

Related U.S. Application Data
(60) Provisional application No. 60/642,638, filed on Feb. 22, 2005.
(60) Provisional application No. 60/646,708, filed on Jan. 25, 2005.

(51) Int. Cl. F16L 9/14

(52) U.S. Cl. 138/149; 138/112; 138/146

(57) ABSTRACT

A system for insulating and providing structural support to pipelines is presented. The system is lightweight and can be constructed to withstand large compressive forces and is applicable to transport of hydrocarbons such as crude oil, gas and LNG including sub-sea applications.

### CROSS-REFERENCES TO RELATED APPLICATIONS

This application claims benefit of priority from U.S. Provisional Patent Applications: 60/642,638 filed Jan. 10, 2005 and 60/646,708 filed Jan. 25, 2005, both hereby incorporated by reference in their entirety.

### STATEMENT REGARDING FEDERALLY SPONSORED RESEARCH OR DEVELOPMENT

None.

### FIELD OF INVENTION

Embodiments of the present invention relate to transport of hydrocarbons such as crude oil, gas and LNG with pipelines.

### DESCRIPTION

In many applications compression resistance and thermal insulation is desired. A non-limiting example is in deep-and ultra-deep-water oil and gas exploration where crude oil or gas is extracted from below the sea floor via a pipeline system to the water surface. Here, it is important to maintain the temperature of the hot crude oil or gas flowing in the pipe above about 30-50° C. depending on the composition of the hydrocarbons (e.g., crude oil or natural gas). Maintaining a temperature in this range prevents flow restrictions or clogging due to formation of hydrates or wax, which can occur via cooling of the crude oil or gas by cold water as the hydrocarbons flow from the underwater well to the production plant on the surface. Also, if the well must be capped for maintenance or due to inclement weather, it is highly desired to keep the temperature of the hydrocarbon inside the pipe and other parts of the pipeline systems (e.g., a Christmas tree or subsea tree, risers, etc.) above precipitation temperature for as long as possible to minimize or avoid expensive and time-consuming de-clogging processes before resuming the pumping operation.

Both rigid and flexible pipelines may have an outer pipe that can withstand external pressures. In a pipe-in-pipe configuration such as that described in the application publication WO 2004/099554, the entire contents of which is herein incorporated by reference, the carrier pipe is designed (independent of the flow line) to withstand the external hydrostatic pressure. The hydrostatic pressure proportionately increases with depth [e.g. about 28 MPa (4000 psi) at 2800 m]. Optionally, in the annular space between the two pipes, spacers (also referred to as “centralizers”), can be installed at regular intervals to provide structural integrity as well as to facilitate assembly. The spacers act as a guide during the insertion of the inner pipe into the outer pipe; each pipe can be 1 or 2 km in length. The spacers are also designed to help maintain the annular gap between the two concentric pipes when the pipe-in-pipe apparatus is bent for winding onto a spool or when it bends after installation.

As the well depth increases, the following obstacles and technical issues have to be overcome. As a starting point, the characteristics of hydrocarbons become more prone to forming wax or hydrates. Additionally, since the distances between the deeper wells and the production plant on the surface platform are significantly increased, the overall-heat-transfer (OHT) value of the pipe-in-pipe apparatus must ordinarily be reduced to very low values, such as 0.5 W/m2-C with a transient cooling requirement of less than 30° C. in 16 hours, to prevent over-cooling of the recovered hydrocarbons. Providing a pipe-in-pipe apparatus with this very-low OHT value would ordinarily necessitate significantly increasing the thickness of insulation, which in turn would increase the inner diameter of the carrier pipe needed to accommodate the additional insulation contained within the carrier pipe.

As the inner diameter of the carrier pipe increases, the carrier-pipe wall thickness that is needed to withstand a fixed external pressure in this context increases as an approximately proportional function of the increase in the outer diameter of the carrier pipe. Moreover, as the depth increases, the external pressure acting upon the carrier pipe increases as a linear function of the depth. For each 10.33 m of water depth, pressure increases by 1 atm (100 kPa). At 2500 m, the hydrostatic pressure reaches about 25 Mpa (3560 psi). The thickness of the carrier pipe wall is increased approximately proportionally with an increase in the hydrostatic pressure for a given inner radius. Therefore, the carrier pipe wall is fabricated with increasing thickness as the pressure for the intended usage is increased, which causes further increase in the outer diameter of the carrier pipe as the intended usage depth increases. Therefore as the exploration depth increases, better thermal insulation and structural integrity is required.

One issue with the pipe-in-pipe design concerns the overall system insulation where spacers are used. Typically the spacers are constructed from metallic alloys (steel) or polymers which exhibit relatively high thermal conductivity (e.g. polyimides such as Nylon) that therefore function as thermal bridges between the carrier pipe and the flow line. It is therefore desirable to employ an alternate material for the spacers or to insulate the spacers from pipe surfaces or to remove the spacers altogether and rely on another type of structural support such as a compression resistant aerogel blanket. The current invention allows for either of these possibilities using organically modified silica aerogel composites that are highly insulating and compression resistant.

Aerogels describe a class of material based upon their structure, namely low density, open cell structures, large surface areas (often 900 m²/g or higher) and sub-nanometer scale pore sizes. Supercritical and subcritical fluid extraction technologies are commonly used during manufacture to extract fluid from the fragile cells without causing their collapse. Because the name aerogel describes a class of structures rather than a specific material, a variety of different aerogel compositions are known and include inorganic, organic and inorganic/organic hybrid compositions. (N. Hüsing and U Schubert, Angew. Chem. Int. Ed. 1998, 37, 22-45).

Inorganic aerogels are generally based upon metal alkoxides and include materials such as silica, various carbides, and alumina. Organic aerogels include, but are not limited to, urethane aerogels, resorcinol formaldehyde aerogels, and polyimide aerogels. Organic/inorganic hybrid aerogels are mainly ormosil (organically modified silica) aerogels. The organic components in this preferred embodiment are either dispersed throughout or chemically bonded to the silica network. Dispersed or weakly bonded organic materials have been shown to be relatively easy to wash out of the gel structure throughout the manufacturing process. Organic materials that are covalently bonded to the inorganic structures would significantly reduce, or eliminate, the amount of washout.

In some embodiment of the present invention low-density aerogel materials (0.01-0.3 g/cc) are considered to be the best solid thermal insulators, significantly better than the best rigid foams (e.g. polyisocyanurate, polyurethane, etc.). For instance, aerogel materials often have thermal conductivities of less than 15 mW/m-K and below at 37.8° C. and one atmosphere of pressure (see J. Fricke and T. Tillotson, Thin Solid Films, 297 (1997) 212-223). Aerogels function as thermal insulators primarily by minimizing conduction (low density, tortuous path for heat transfer through the solid nanostructure), convection (very small pore sizes minimize convection), and radiation (IR absorbing or scattering dopants are readily dispersed throughout the aerogel matrix). Depending on the formulation, they can function well from cryogenic temperatures to 550° C. and above. Aerogel materials also display many other interesting acoustic, optical, mechanical, and chemical properties that make them useful in both consumer and industrial markets.

Although the diffusion of polymerized silica chains and subsequent solid network growth are significantly slowed within the silica gel structure after the silica gelation point, the maintenance of the original gel liquid (mother liquor) for a period of time after gelation is known in the art to be essential to obtaining an aerogel that has the best thermal and mechanical properties. This period of time that the gel “ages” without disturbance is called “syneresis”. Syneresis conditions (time, temperature, pH, solid concentration) are important to the aerogel product quality.

Conventional methods for monolithic gel and/or fiber-reinforced composite gel production formed via sol-gel chemistry described in the patent and scientific literature invariably involve batch casting. Batch casting is defined here as catalyzing one entire volume of sol to induce gelation simultaneously throughout that volume. An alternate process to form monolithic and/or fiber-reinforced composite gel structures has been described in published US patent application number US2002/0094426A1, wherein sols are catalyzed (in the presence of fiber in the case of fiber-reinforced composites) in a continuous stream prior to gelation. Gel-forming techniques are well-known to those trained in the art. Examples include adjusting the pH and/or temperature of a dilute metal oxide sol to a point where gelation occurs (R. K. Iler, Colloid Chemistry of Silica and Silicates, 1954, chapter 6; R. K. Iler, The Chemistry of Silica, 1979, chapter 5, C. J. Brinker and G. W. Scherer, Sol-Gel Science, 1990, chapters 2 and 3). Suitable materials for forming inorganic aerogels are oxides of most of the metals that can form oxides, such as silicon, aluminum, titanium, zirconium, hafnium, yttrium, vanadium, and the like. Particularly preferred are gels formed primarily from alcohol solutions of hydrolyzed silicate esters due to their ready availability, low cost, and ease of processing. The organic forms can be based on, but are not limited to, compounds such as, urethanes, resorcinol-formaldehydes, melamine-formaldehyde, phenol-furfural, polyimide, polyacrylates, chitosan, polymethyl methacrylate, members of the acrylate family of oligomers, trialkoxysilylterminated polydimethylsiloxane, polyoxyalkylene, polyurethane, polybutadiane, and a member of the polyether family of materials or combinations thereof. (some are also discussed in N. Hüsing and U Schubert, Angew. Chem. Int. Ed. 1998, 37, 22-45).

The mechanical properties of silica aerogels and xerogels can be improved in order to reduce their tendency to crack during the formation of monolithic gel structures, by the incorporation of a secondly polymeric phase directly bonded to silica network. Some of the most noticeable examples are as follows:

N. Leventis, C. Sotiriou-Leventis, G. Zhang and A. M. Rawashdeh, Nano Letters, 2002, 2(9), 957-960, report the increment of strength of silica aerogel by a factor over 100 through cross-linking the silanols of the silica hydrogels with poly(hexamethylene diisocyanate). The resultant material, however, contains hydrolysable bonds between the silicon and oxygen atoms in —Si—O—C— and no Si—C bonds. H. Schmidt, J. Non-Cryst. Solid, 73, 681, 1985, reported the increase of the tensile properties of silica xerogel by the incorporation of polymethacrylate (referred as PMA there after).

Ormosil aerogels are discussed in US patent applications 2005/0192367 and 2005/0192366 both hereby incorporated by reference.

To distinguish between aerogels and other ambient environment dried materials (such as xerogels), it is pointed out that aerogels are a unique class of materials characterized by their low densities, high pore volumes, and nanometer pore sizes. Because of their high pore volumes and nanometer pore sizes, they typically have high surface areas and low thermal conductivities. The high porosity leads to a low solid thermal conductivity, and the nanometer pore sizes cause partial suppression of gaseous thermal conduction because the pore diameters are typically smaller than the mean free path of gases. This structural morphology of an aerogel is a major advantage in thermal insulation applications. For instance, thermal conductivities have been measured to be less than 15 mW/m·K at ambient conditions for silica aerogels (see J. Fricke and T. Tillotson, Thin Solid Films, 297 (1997) 212-223) and as low as 12 mW/m·K for organic aerogels. This is in sharp contrast to xerogels, which have higher densities than aerogels and are used as a coating such as a dielectric coating.

The sol-gel process has been used to synthesize a large variety of inorganic, organic and fewer hybrid inorganic-organic xerogels, aerogels and nanocomposite materials. Silica gels are frequently used as the base material for inorganic and hybrid inorganic-organic material synthesis. Relevant precursor materials for silica based aerogel synthesis include, but are not limited to, sodium silicates, tetraethylorthosilicate (TEOS), tetramethylorthosilicate (TMOS), monomeric alkylalkoxy silanes, bis trialkoxy alkyl or aryl silanes, polyhedral silsesquioxanes, and others. Various polymers can be incorporated into silica gels to improve mechanical properties of the resulting gels, xerogels, and aerogels. Aerogels are obtained when the gels are dried in a manner that does not alter or causes minimal changes to the structure of the wet gel. This is typically accomplished by removing the solvent phase from the gel above the critical point of the solvent or mixture of solvents if a co-solvent is used to aid the drying process.

A physical admixture of an organic polymer distributed in a silica gel matrix can affect the physical, chemical, and mechanical properties of the resulting hybrid material. Polymeric materials that are weakly bound to the silica gel structure, typically through hydrogen bonding to Si—OH (silanol) structures, can be non-homogeneously distributed throughout the material structure due to phase separation in the manufacturing process. In the case of composite aerogel manufacture, weakly bonded or associated polymer dopants can be washed out during the conversion of alcogels or hydrogels to aerogels during commonly used solvent exchange steps. A straightforward way to improve binding of the dopant polymer or modifier to the composite structure is to selectively react latent silanol functionalities within the fully formed silica gel structure with various reactive moieties (e.g. isocyanates), such as that taught by Leventis et al (Nano Letters, 2002, 2(9), 957-960 and US published application 20040132846A1). If the resulting chemical structure results in a Si—O—X linkage, the group X is readily susceptible to hydrolytic scission in the presence of water.

In an embodiment, ormosil aerogels as previously introduced are utilized as thermal insulators which additionally provide the benefit of mechanical strength.

### SUMMARY OF INVENTION

The thermal insulation systems of this disclosure can be used for such diverse applications as deep-water pipeline insulation, LNG tanker insulation, process piping, etc. These systems insulation systems can be characterized as follows: lightweight, thin, low-cost, high thermal-insulation performance and high load-bearing capability, as well as being easily installed and maintained. Low-density silica aerogels offer excellent insulation with up to five times the thermal-insulation performance of commonly used fiberglass in ambient conditions and can support high loads. Fiberglass is cheap, but it is too bulky and ineffective; moreover, fiberglass is non-load-bearing, and its installation is messy. Foam can be load-bearing to a very limited extent, however, the thermal-insulation performance is too low. The advanced embodiments of insulated structures, described below, can be used for deep-water and especially for ultra-deep-water oil-and-gas exploration and other application. Embodiments of the present invention utilizes solvent filled, nanostructured gel structures as well as the resultant fiber reinforced gel composites produced there from. The gel structures become nanoporous aerogels after all mobile phase solvents are extracted via a process such as supercritical fluid extraction. The formulation and processes provided by embodiments of the present invention offer improved mechanical properties for aerogel monoliths and composites once extraction is complete. The novel, organically modified silica is referred as an ormosil [organically modified silica]. The described method and apparatuses utilize compression properties of aerogel composites, making them better suited for compression resistant applications such as insulation for underwater oil and gas pipelines.

### BRIEF DESCRIPTION OF THE DRAWINGS

FIG. 1 is an exposed, perspective view showing a flow line, a helical spacer and a carrier pipe.

FIG. 2 is a magnified view of the apparatus

FIG. 3 is a partially cut-away perspective view of the detail of a spacer having a triangular cross-section, with a weld strip and a load-bearing insulation

FIG. 4 is a perspective view of a carrier pipe with an aerogel material and a spacer material co-wounded helically thereabout

FIG. 6 is a perspective view of a membrane enclosed aerogel material, co-wounded with a spacer material

FIG. 7 is a perspective view of a hollow spacer helically wound about the flow line and a cut-away view showing the aerogel material filling the hollow spacer.

FIG. 8 is a perspective view of a pipe-in-pipe where both the flow line and the carrier pipe are coated with a corrosion resistant polymer

FIG. 9 is a perspective view of a spacer-less pipe in pipe system wherein the aerogel material is compression resistant and encased in a membrane

FIG. 10 is a perspective view of a pipe-in-pipe system with a spacer comprising partially of entirely of aerogel material, in conjunction with an aerogel blanket covering the rest of the annular space.

FIG. 11 is a cut-away view of the system of FIG. 10.

FIG. 14 is perspective view of a flexible pipeline having a compression resistant aerogel wrapping the flow line encased in a metallic strip helically wound about the aerogel blanket.

### DETAILED DESCRIPTION

Traditional pipe-in-pipe designs, rely on the outer carrier pipe having sufficient thickness and strength to handle the external load on its own without collapsing under normal operating conditions. By necessity, this makes the outer wall of the carrier pipe relatively thick. For pipe-in-pipe configurations where spacers are utilized, placement of the spacers 10 is a matter of optimization. If the spacing is too large, the wall thickness of the carrier pipe 14 will have to be thick; and if the spacing is too small, the wall thickness of the carrier pipe 14 will be thin but the thermal conduction loss through the spacer 10 will increase. For optimization of spacer 10 spacing, the material properties of the spacer 10, such as thermal conductivity and mechanical strength of the carrier wall, are taken into account to arrive at the right spacing. Greater mechanical strength of the carrier wall and greater thermal conductivity of the spacer 10 both encourage the adoption of greater distances between the spacers 10 (or between revolutions of a spacer in a helical configuration). The spacers 10 can be made from structurally strong material such as steel or high-strength composites. Given that reduction of thermal conduction across the spacers is of great importance, the following solutions are available. In one particular embodiment, the spacer 10 includes a separate layer of thermal insulation that can withstand the compressive load. Furthermore the layer of insulation that can withstand the compressive load may be an aerogel or aerogel comprising material. Alternatively, the spacers can be hollow structured and filled with an aerogel material for added insulation. Another solution is constructing spacers partly, or entirely from aerogel materials that are compression resistant. This not only reduces overall weight but also achieves superior thermal insulation over other spacer materials.

In another embodiment, the carrier pipe 14 (rigid or flexible) is mechanically supported by an advanced insulation in the annulus (that has both excellent thermal-insulation capability and excellent compressive strength). That is, spacers may not be needed in this particular configuration. The thermal conductivity of the insulation material can be, e.g., 50 mW/m*K or less. The principal stress experienced by the thin wall of the carrier pipe 14 under external pressure load in this embodiment is radial and mostly compressive. The advanced insulation in this embodiment has sufficient structural strength to withstand the mechanical load and can provide an excellent level of thermal insulation. Compression resistant aerogel materials for instance, can fill this role very well.

In a related embodiment where the spacer is made of the special structural insulation material and fills the annulus along the length of the pipes rather than being placed apart at intervals as in the earlier embodiment in the first embodiments.

The spacers can be formed of an aerogel, such as a pre-conditioned silica aerogel or a high-strength cellulose aerogel, such as those available from Aspen Aerogels (Northborough, Mass., USA). Aerogels are described in greater detail in U.S. Pat. No. 6,670,402, which is incorporated herein by reference in its entirety. Aerogel composites reinforced with a fibrous batting, herein referred to as “blankets”, are particularly useful for applications requiring flexibility since they are conformable and provide excellent thermal conductivity. Aerogel blankets and similar fiber-reinforced aerogel composites are described in published US patent application 2002/0094426A1 and U.S. Pat. Nos. 6,068,882, 5,789,075, 5,306,555, 6,887,563, and 6,080,475, all hereby incorporated by reference, in their entirety. In one aspect of the present invention the insulating layer comprises aerogel beads, particles or monoliths in combination with fiber forms.

A silica aerogel can be pre-compressed to the maximum pressure level anticipated in the operation; pre-compressed silica aerogels have been found to show little deterioration in thermal performance for the same thickness after they are compressed. Cellulose aerogels exhibit extremely high structural strength even without pre-compression, while still providing excellent thermal insulation performance. It is important to note that water and air from the moist air condensation in the annular space can negatively influence the properties of aerogel materials. To that end, some of the following methods are useful. For enhanced performance, aerogels can be sealed under reduced pressure (preferably vacuum) before placing them around the flow line. This is highly beneficial since at lower pressures such as that of a vacuum, thermal conductivity is considerably reduced. Also, aerogel materials can be encased within a membrane such that it prevents air or water from entering the material while allowing air or water to escape.

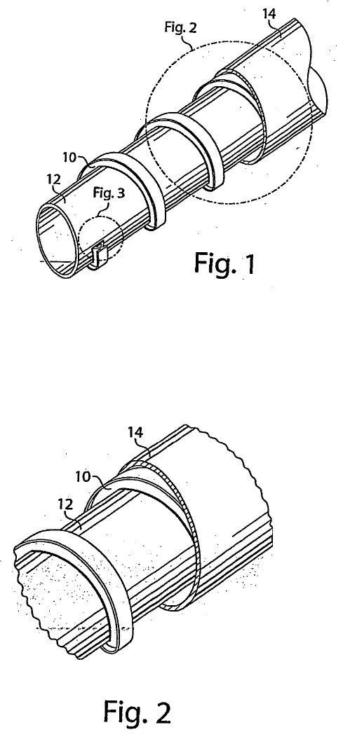

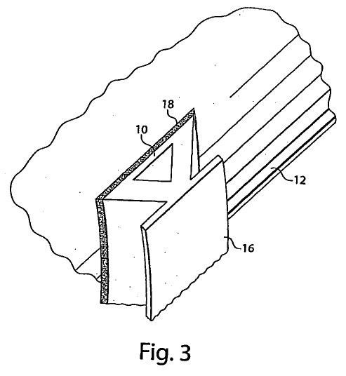

In the design illustrated in FIGS. 1-3, a thin spacer 10 is helically wound over the flow line 12. The angle of the helix is between zero degrees (i.e., discrete spacer rings) and eighty degrees, where the actual angle depends on the width of the spacer used and the required gap between spacers. The spacer 10 supports a relatively thin carrier pipe 14 (see FIG. 2). In the embodiment of FIG. 3, the triangular cross section of the spacer 10 is evident; the triangular cross section is especially amenable to a winding operation and is capable of handling well the concentrated load coming from the carrier pipe 14 under external load. A weld strip 16 (optional) and load-bearing insulation 18 (optional) can also be seen in FIG. 3.

The optional weld strip 16 is welded to the spacer 10 (extending beyond the flat top surface of the spacer 10) and to the carrier pipe 14 and serves to ensure the integrity of the welding and to provide high welding strength. The weld strip 16 also spreads the external load, thereby reducing the stress concentration in the carrier pipe 14 under operating load. The optional load-bearing insulation 18 will ensure significant reduction in the heat transmitted from the wall of the carrier pipe 14 through the weld strip 16 and through the main structural body of the spacer 10 with the triangular cross-section. The spacer 10 envisioned here structurally supports the carrier pipe 14 and also thermally separates the flow line 12 and the carrier pipe 14 very effectively.

The spacers 10 are supported in the radial direction by the flow line pipe 12. The spacers 10 take the load transmitted through the contact surface with the carrier pipe 14. Under pressure loading both from inside the flow line 12 and from outside the carrier pipe 14, the spacers 10 become the mechanical link between the carrier pipe 14 and the flow line 12.

In fact, this bi-directional load transmission has the beneficial effect of at least partially balancing the inner tube pressure of the hydrocarbons with the outer pressure of the sea water. For example, if the inner pressure coming from the hydrocarbon is 69 MPa (10,000 psi) for the flow line pipe 12, and if the outside pressure for the carrier pipe 14 caused by the sea water is 28 MPa (4000 psi), the effective loading on the flow line 12 is only 41 MPa (6000 psi). Seen another way, the spacers 10 can be regarded as “girders” for the flow line 12. Because of the pressure balancing and the girder effects of the spacers, the wall thickness for the flow line 12 can also be reduced, in accordance with the effective reduction in the loading experienced by the flow line 12 as described above.

Compression Resistant Aerogels

Compression resistance in the context of the present invention can take on two non-exclusive definitions. In one instance, compression resistance can be defined as a percent elastic recovery (thickness recovery) of a material after a fixed load has been applied and subsequently removed. For the aerogel materials described this invention the recovery value is at least about at least about 50%, at least about 60%, at least about 70%, at least about 80%, or at least about 90% for a given density and load range. These ranges in the present invention are: about 0.05 g/cm³ to about 0.25 g/cm³ for density and approximately 4000 psi and below for pressure. Also, compression resistance can be defined as the mechanical resistance to deformation under a fixed load. That is, a percent strain under a constant load. For the materials described in this invention, this value less than about 30%, less than about 20%, less than about 10% or less than about 5%. The above mentioned ranges also apply to the latter definition.

The nano-reinforcement component used in the present invention includes and is not limited to the PMA family of polymers, i.e. polymethyl methacrylate (referred as PMMA there after), polybutyl methacrylate (referred as PBMA there after), polyhydroxyethyl methacrylate (referred as PHEMA there after).

There are number of ways to incorporate this kind of polymer into silica network. The present invention uses a cross linker trimethylsilyl propylmethymethacrylate (referred as TMSPM there after) to increase the miscibility of the two separated phase in the system. TMSPM have both polymerizable methacrylate component and condensable trimethoxysilyl function, as illustrated in FIG. 2. The hydrolysis and condensation of this compound will link it to the silica network, whilst the polymerization of this compound will link it into the PMA phase. In principle this cross-linker will act as a hook between the silica network and polymethacrylate linear. The presence of extensive hydrogen bonding between silianols of the silica network and the carbonyl group on the PMA also favor the formation of the homogeneous gel. These interactions between polymeric and silica phase can inhibit phase separations.

TMSPM was polymerized with methacrylate monomer to form trimethoxysilyl grafted polymethacrylate oligomer, as illustrated in FIG. 3. Thermal initiator, such as Azobisisobutyronitrile (referred as AIBN there after) or tert-butylperoxy-2-ethyl hexanoate, initiated the polymerization. The methacrylate monomer includes and not limit to methylmethacrylate (referred as MMA there after), ethylmethacrylate (referred as EMA there after), butylmethacrylate (referred as BMA there after), hydroxyethylmethacrylate (referred as HEMA there after), hexafluorobutyl methacrylate (referred as HFBMA there after), etc. The polymerization was carried out in lower alcohol solutions at elevated temperature between 40 to 100° C. and preferably 70 to 80° C. The ensure a fast reaction the reactant concentration in alcohol solution needs to be in the range between 5 to 95 weight percent, preferable form 40 to 70 weight percent. The mole ratio of TMSPM/methacylate monomer is on the range between 1 to 10 and preferable 1 to 4. The resulting trimethoxysilyl grafted polymethacrylate oligomer should be relatively low molecular weight, soluble in common organic solvents.

Generally the principal synthetic route for the formation of an ormosil aerogel is the hydrolysis and condensation of an appropriate silicon alkoxide, together with an oganotrialkoxylsilane. The most suitable silicon alkoxides are those having about 1 to 6 carbon atoms, prefer-ably from 1-3 carbon atoms, in each alkyl group. Specific examples of such compounds include tetraethoxysilane (referred as TEOS there after), tetramethoxysilane (referred as TMOS there after), tetra-n-propoxysilane. These materials can also be partially hydrolyzed and stabilized at low pH as polymers of polysilicic acid esters such as polydiethoxysiloxane. Polyethysilicate formulations commercially available from Silbond Corp, Dugussa Inc. and other vendors. Higher molecular weight silicone resin can also be used in this ormosil formulation, this silicone resin includes and not limit to Dow Corning Fox series, Dow Corning Z6075, Dow Corning MQ resin, etc.

Gel materials formed using the sol-gel process can be derived from a wide variety of metal oxide or other polymer forming species. Sols can be doped with solids (IR opacifiers, sintering retardants, microfibers) that influence the physical and mechanical properties of the gel product. Suitable amounts of such dopants generally range from about 1 to 40% by weight of the finished composite, preferably about 2 to 30% using the compositions of this invention.

Major variables in the ormosil aerogel formation process include the type of alkoxide, solution pH, and alkoxide/alcohol/water ratio, silica/polymer ratio and monomer/cross linker ratio. Control of the variables can permit control of the growth and aggregation of the matrix species throughout the transition from the “sol” state to the “gel” state. While properties of the resulting aerogels are strongly affected by the silica/polymer ratio, any ratio that permits the formation of gels may be used in embodiments of the present invention.

Generally, the solvent will be a lower alcohol, i.e. an alcohol having 1 to 6 carbon atoms, preferably 2 to 4, although other liquids can be used as is known in the art. Examples of other useful liquids include but are not limited to: ethyl acetate, ethyl acetoacetate, acetone, dichloromethane, and the like.

For convenience, the alcogel route of forming ormosil gels and composites are used below to illustrate how to create the precursors utilized by the invention, though this is not intended to limit the present invention to the incorporation of any specific type of PMA into silica network. Embodiments of the invention is applicable to other ormosils with other similar concept structures.

After identification of the gel material to be prepared using the methods of this invention, a suitable silica alkoxide/triethoxylsilyl grafted PMA oligomer alcohol solution is prepared. The preparation of silica aerogel-forming solutions is well known in the art. See, for example, S. J. Teichner et al, Inorganic Oxide Aerogel, Advances in Colloid and interface Science, Vol. 5, 1976, pp 245-273, and L. D. LeMay, et al., Low-Density Microcellular Materials, MRS Bulletin, Vol. 15, 1990, p 19. For producing ormosil ges, preferred ingredients are partially hydrolyzed alkoxysilane, trimethoxylsilyl grafted PMA oligomer, water, and ethanol (EtOH). All of the above mentioned ingredients were mixed together at ambient or elevated temperature.

Partially hydrolyzed alkoxysilanes, and polyethysilicates are preferably used. The preferred mole ratio of SiO₂ to water is about 0.1-1:1, the preferred mole ratio of SiO₂ to MeOH is about 0.02-0.5:1, and the preferred PMA/(PMA+SiO₂) weight percent is about 5 to 90. The natural pH of a solution of the ingredients is about 5. While any acid may be used to obtain a lower pH solution, HCl, H₂SO₄ or HF is currently the preferred acids. To generate a higher pH, NH₄OH is the preferred base.

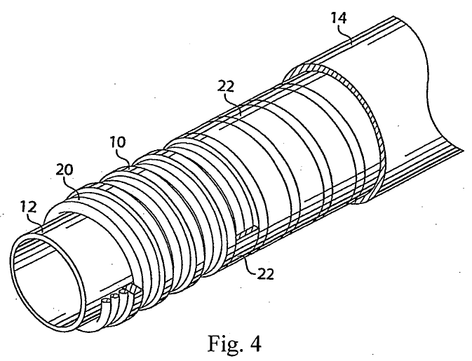

A transparent ormosil gel monolith with 1 to 80-weight % (preferably 5 to 70%) loading of PMA was formed after the addition of condensation catalyst, according to the scheme illustrated in FIG. 4. The catalyst may be NH₄OH, NH₄F, HF, and HCl. This gel will turn opaque after CO₂ supercritical extraction. The resulting ormosil aerogels have density range from 0.05 to 0.40 and thermal conductivity range from 10 to 18 mW/mK. The reinforcement effect of PMA leads to great improvement of mechanical properties. Up to 102.2 psi flexural strength at rupture was measured on a 0.3 g/cm3 density PHEMA/silica aerogel. This particular ormosil aerogel deformed less than 1% under the loading of 100 psi.

For fiber-reinforced ormosil aerogel composites, Pre-polymerized silica precursors are also especially preferred as the silica precursor. The effect of the other variation factors is similar to those in the preparation of ormosil aerogels.

As used herein a lofty batting may be a fibrous material that shows the properties of bulk and some resilience (with or without full bulk recovery). The use of a lofty batting reinforcement material minimizes the volume of unsupported aerogel while avoiding substantial degradation of the thermal performance of the aerogel. Batting preferably may be layers or sheets of a fibrous material, commonly used for lining quilts or for stuffing or packaging or as a blanket of thermal insulation.

Batting materials that have some tensile strength are advantageous for introduction to the conveyor casting system, but are not required. Load transfer mechanisms can be utilized in the process to introduce delicate batting materials to the conveyor region prior to infiltration with prepared sol flow.

Suitable fibrous materials for forming both the lofty batting and the x-y oriented tensile strengthening layers include any fiber-forming material. Particularly suitable materials include: fiberglass, quartz, polyester (PET), polyethylene, polypropylene, polybenzimid-azole (PBI), polyphenylenebenzo-bisoxasole (PBO), polyetherether ketone (PEEK), polyarylate, polyacrylate, polytetrafluoroethylene (PTFE), poly-metaphenylene diamine (Nomex), poly-paraphenylene terephthalamide (Kevlar), ultra high molecular weight polyethylene (UHMWPE) e.g. Spectra™, novoloid resins (Kynol), polyacrylonitrile (PAN), PAN/carbon, and carbon fibers.

The resulting fiber reinforced PMA/silica aerogel composite have a density between 0.05 to 0.25 g/cm³, and thermal conductivity between 12 to 18 mW/mK. The reinforcement effect of PMA leads to a great improvement of compression property of the aerogel composite. Less than 10% compression deformation was observed in the examples of this ormosil aerogel under the loading of 17.5 psi. The high strength fiber reinforced PMA/silica aerogel composite with density at 0.18 g/cm³ recover up to 94.5% of its original thickness after compression at 4000 psi.

Spacer Design

The spacers can be discrete rings or of continuous helical design as shown in FIG. 1. In an extreme case, a spacer is a full cylinder occupying the annulus formed between the inner flow line and the outer carrier pipe. Apart from the above-mentioned limiting case, the cross section of the spacer can be either solid or tubular (hollow) and can take a variety of shapes, such as a circle or triangle, depending on the material and the operating conditions one chooses. Furthermore, the tubular cross sectional spacer design can incorporate a filling material such as an aerogel without compromising overall flexibility of said spacer. FIGS. 1-3 show a rendering of a helically wound spacer with a special cross section designed to perform multiple functions well. The cross-section of the spacer should be such that it will be conducive to being bent around the pipe without collapsing the tubes. For example, triangular, circular, elliptical and trapezoidal tubes can be easily wound around a pipe in a controlled manner without overly collapsing the interior volume of the tube. FIG. 3 shows the details of this particular helical spacer 10 that includes a tubing of triangular cross section between a load-bearing and insulating strip 18 at the bottom and a flat strip 16 on top. The triangular shape was chosen to handle the compressive loading and to minimize the heat transfer from the carrier pipe 14 to the spacer 10 and to the flow line 12.

The overall heat transfer value from the carrier pipe to the flow line can be, e.g., 5 W/m2-C or less. The lower part (i.e., the side facing the flow line pipe 12) of the spacer 10 has a load bearing and insulating strip 18 in the form of a high-compressive-strength aerogel strip designed to thermally isolate the metal spacer coil 10 from the inner flow line 12. The aerogel strip can be formed of pre-compressed fiber-reinforced silica aerogels or non-compressed PMMA/silica hybrid, both having the requisite properties of high structural strength and excellent thermal insulation. The thickness of the strip will be determined by the insulation requirement for the spacer 10 and will generally range between 1 mm to the full gap dimension of the annulus between the flow line 12 and the carrier pipe 14, the latter case signifying the use of structural insulation as the full spacer 10. The flow line 12 is designed to handle the high-pressure hydrocarbon flow just like the flow lines currently in use.

The spacers 10, regardless of their design, are chosen to give very-high thermal resistance either via small contact areas preferably at the interfaces between the spacer 10 and the carrier pipe 14 and the flow line 12, as shown, or by using a load-bearing thermal insulation material for the spacers 10 or by placing a strip made of such a material between the spacers 10 and one or both of the pipes 12,14. The spacers 10 can be discrete ring spacers or can be helically wound strips or tubes of various cross-sections.

The spacer cross-sections include, but are not limited to, tubes of circular or triangular cross-sections or solid rods of rectangular, circular or triangular cross-sections. The tubular spacers can be either evacuated, pressurized with fluids, or in pressure equilibrium with the annular space through breather holes. The spacers can also comprise an aerogel material for thermal insulation. For example a hollow spacer can be filled with an aerogel to achieve insulating properties without significantly altering the mechanical performance of said spacer. Also, spacers can be constructed entirely of an aerogel material which is compression resistant.

Insulation Materials

The gap created between the two concentric pipes and the spacers can be evacuated, with radiation shields, partially or entirely filled with insulation materials, or simply filled with gases. Preferably, insulation materials such as low thermal conductivity gases, aerogels, or any other effective insulation material can be inserted in the annular space created between the flow line 12, the spacer 10 and the carrier pipe 14 depending on the requirements for the pipe-in-pipe installation and application at hand. Additionally, the aerogel material can be encased in a membrane to prevent air and water from entering while allowing air and water to leave the material. This procedure enhances the insulating performance of the aerogel. Aerogels can also be encased within a compression resistant polymer to provide added mechanical strength. It is important to note that the term “aerogel” in this application refers not only to reinforced aerogel materials but to all present forms of aerogels such as, but not limited to: aerogel particles, aerogel beads, aerogel blankets, fiber-reinforced aerogels, aerogel monoliths and any combination thereof.

Corrosion Resistant Pipes

When ferrous pipes are in contact with an aqueous media corrosion can occur and eventually lead to pipe failure. This may be due to water inside the annular space between the flow line and the carrier pipe or the sea environment acting on the exterior of the outer pipe. In both cases, a corrosion resistant layer such as a polymer may be applied on the surfaces of interest.

Spacer-Less Configuration of Pipe-in-Pipe Apparatus

Previously, designs using a spacer within the annular space between the flow line and the carrier pipe, with or without an insulating material have been described. In a special embodiment, the pipe-in-pipe apparatus can be constructed to function properly without using spacers. Compression resistant insulating materials such as ormosil aerogels, can be wrapped around the flow line to provide excellent insulation while withstanding compressive forces from the carrier pipe. The advantages of this design are numerous. First, eliminating spacers that are potential thermal bridges improves overall insulation of the flow line. Second, by using only compression resistant insulating material, such as an aerogel, overall weight can be reduced. This is especially apparent when compared with the configuration involving steel spacers in kilometers of pipeline.

Use of the Load-Bearing Lightweight and Compact Super Insulation System

So far, the new load-bearing, lightweight, compact, super-insulation system has been described for deep and ultra-deep underwater structure applications among others. The system can be applied to many parts of the underwater oil exploration system that requires effective thermal insulation under high external pressure, such as a flow line, a riser, a Christmas tree or subsea tree, in-field lines, and any other parts that would benefit from compact, lightweight super insulation with a relatively thin protective skin. Similar systems can be easily extended to insulate the LNG tankers and any other applications where the high load-bearing capability is required.

Insulation for a Liquefied Natural Gas (LNG) Tanker

A brief explanation as to how this insulation system would be used to effectively insulate a large system, such as an LNG tanker, follows. Unlike a pipe-in-pipe apparatus, the LNG tanker carries a large volume of liquefied natural gas inside the tank. The tank undergoes significant geometric/dimensional changes when the liquefied natural gas, which is at a cryogenic temperature, is introduced. The insulation system is designed either to move with the tank when it shrinks and expands or to be localized in order to avoid large displacements if all the spacers are connected throughout. In either case, there will be relative motion between the insulation system and the tanker or the outer shell if it is a double shell design depending on where the insulation system is physically attached.

For the sake of simplicity, we will assume that the insulation system is attached to a flat outer shell and the flat-bottomed LNG tank is supported by the insulation system. The relative movement of the LNG tank would be in the x-y plane at the interface between the LNG tank and the bottom plate. In this case, the insulation system includes (a) spacers that bear the weight load of the vessel containing the liquefied natural gas and (b) thermal insulation, such as a non-load-bearing aerogel, placed between the spacers. The spacers include load-bearing and insulating (e.g., aerogel) strips to minimize heat conduction through the spacers. It is also possible to use load-bearing aerogels to fill the gap between the LNG tank and the outer wall and, in a special case, without the use of separate spacers. In the special case, the load-bearing aerogel compression resistant layer is the spacer.

Insulation and Support Structure for a Flow Pipe for Transporting Liquified Natural Gas:

In another embodiment, the inner flow pipe carries liquified natural gas at ambient pressures or at slightly elevated pressures and is further mechanically supported by spacers (a k.a., centralizers) or other mechanical structures that are placed in the annular space between the carrier pipe and the flow pipe. Insulating materials, such as aerogel particles or aerogel blankets, are positioned in the annular space to effectively insulate the fluid from gaining heat in the case of liquefied natural gas (LNG) transport and to prevent heat loss in the case of oil transport. Centralizers made of mechanically strong materials (e.g., steel) are used and further insulated with aerogel material to reduce heat conduction through the centralizers. Aerogel material is also inserted in the annular space between the pipes and between any two centralizers in the axial direction. If aerogel blankets are used, the blankets can be staggered on top of each other around the edges to limit heat loses. After positioning the blankets, restriction means are used to make sure the blankets do not move out of place easily. Such an embodiment can be practiced either at normal external pressures or at high external pressures such as under sea environments. The present invention provides ways to transport natural gas as a liquid which is otherwise transported as a gas in pipelines.

Liquefied natural gas (LNG) is transported at low temperatures of about −250 to 260 F. Even small perturbations in the temperature can cause undesirable changes in pressure that have to be taken in to account during the flow pipe design. The present invention provides flexibility in such designs due to the effectiveness of the insulation system.

Use of a Phase-Change Material (PCM):

A phase-change material (PCM) can be introduced in the space between spacers or even inside spacer tubes if the spacer tubes are not used as a heat pipe system. During shut-down periods, the heat stored in the PCM will be slowly released to the hydrocarbon contained inside the flow line while the insulation covering the PCM will keep the heat inside substantially shielded from the cold sea water. By providing excellent thermal insulation between the cold seawater and the PCM, the PCM can maintain the hydrocarbons above the desired temperature for a longer period of time than can a pipe in pipe system with inferior insulation value. One example of a suitable PCM is wax; particularly petroleum/paraffin wax, which can melt and re-solidify as the temperature of the hydrocarbons rises and falls. For example, some oil compositions can be transported at 160-180 F, where waxes have typical melting points. However, by manipulating the wax composition, the PCM can be created to have a varied melting point depending on the transport temperature. The PCM would transfer heat back into the flowing hydrocarbons as the PCM solidifies from a melt. The PCM can also be positioned in the annular space between the carrier pipe and the outer pipe when no spacers are utilized. This can be achieved effectively in a variety of ways such that the PCM in the annular space, in thermal contact with the flow line and insulated from the outer pipe. For instance, in several patents to Frisby Technologies inc., a method is presented to encapsulate PCM's in a glass-like coating while preserving the functionality of the PCM. Similarly, PCM's can potentially be incorporated into the sol-gel process of preparing aerogels.

Geothermal Heat Pipe to Keep the Hydrocarbons Warm During Operation and Shutdown:

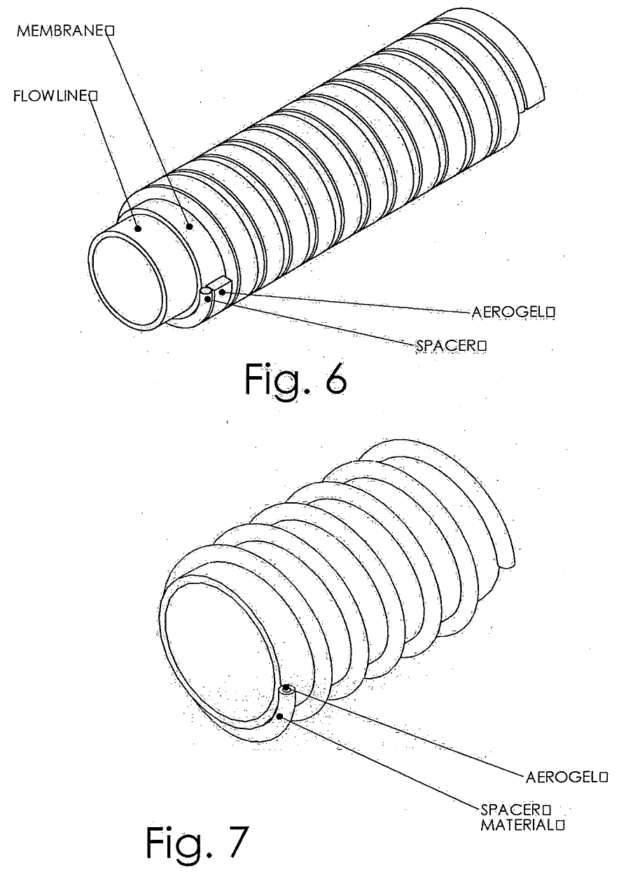

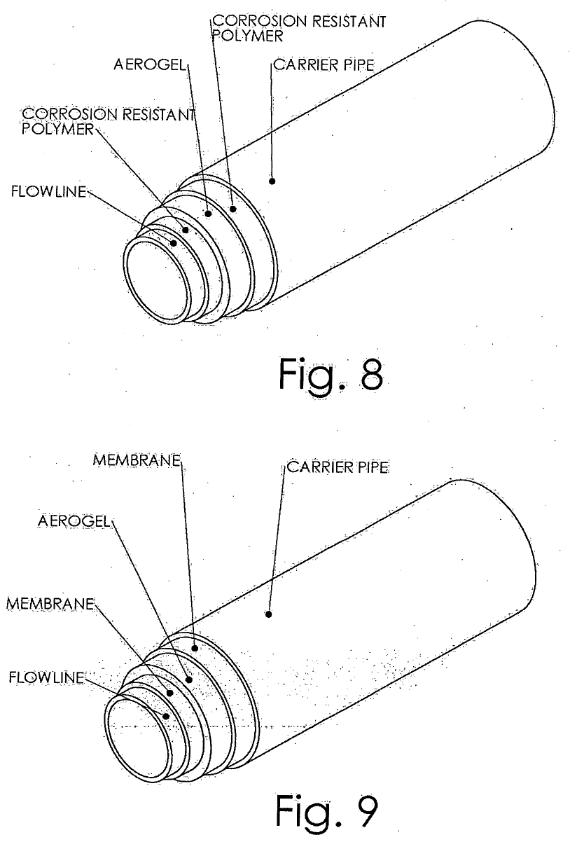

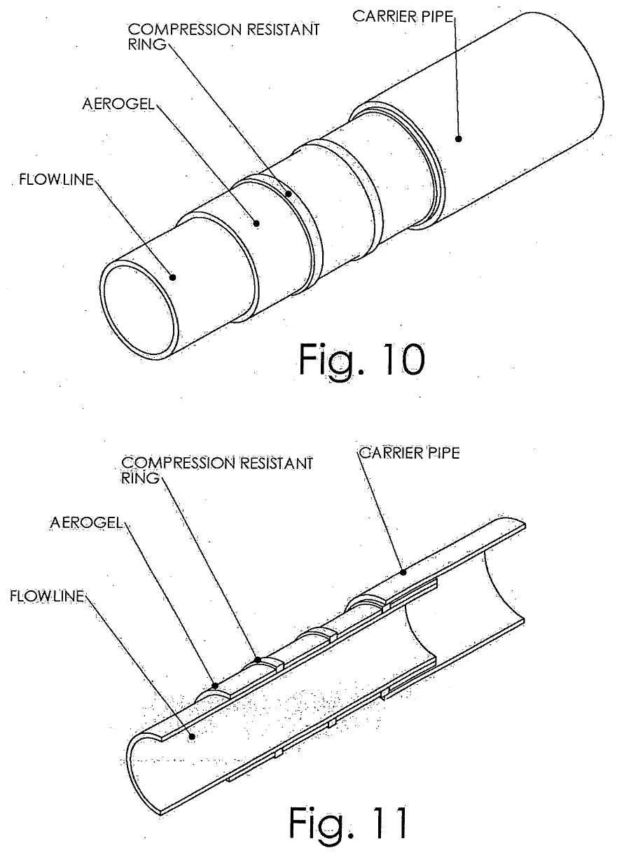

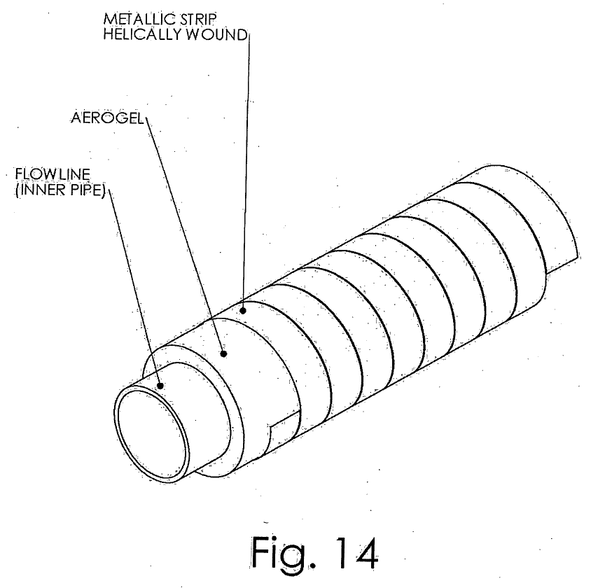

If the helical spacer coils are equipped with appropriate passages (such as a fine mesh layer functioning as wicks) for a liquid phase and vapor core at the center, contiguously connected over a required long distance, and filled with an appropriate heat-pipe fluid (examples provided below), a heat pipe system can be created that utilizes the geothermal energy from below the sea bottom to keep the hydrocarbons in the pipe in pipe and other subsea systems above the precipitation temperature for an extended period during normal operation or even during shutdown periods for maintenance or storm. Such an apparatus is illustrated in FIG. 6, where coiled heat pipes 20 fill the gap between turns of a coiled spacer 10 on a flow line extending from the ocean floor, at bottom, through the water, above. An appropriate heat-pipe fluid is a fluid that changes its state from liquid to vapor or vice versa within the temperature and pressure limits of the system in operation. Examples include water, alcohol, glycol, sodium, etc. As shown in FIG. 7, separate heat pipe tubes 20 run between turns of a coiled spacer 10 and are thermally insulated by aerogel insulation layers 22.

The heat-pipe fluid moves according to the following path within the conduit. The liquid from the cold side of the conduit is transported by the surface tension of the liquid acting on the fine wick layer on the inner perimeter of the tube to the hot side where the liquid boils away and collects into the vapor channel (most prevalently in the core region).

The vapor pressure generated by boiling drives the vapor toward the cold region. Once the vapor reaches the cold region, it condenses to liquid and gets into the wick to be sent back to the hot spot by surface tension induced pumping within the wick layer. The heat pipe system will obviate the need for the electrical heating or other heating methods that are very expensive to install, maintain and thus far less desirable than the heat pipe system, described above.

Flexible Pipeline Applications

Solid steel pipes described in the aforementioned pipe-in-pipe applications, are capable of being reeled onto wheels of 50 foot diameter and, for the purposes of the present application are not considered “flexible”. Flexible pipes considered for this invention resemble those described in U.S. Pat. Nos. 5,307,842 and 6,283,161, both herein incorporated entirely by reference. Such flexible pipes may have the basic structure of an inner tube constructed from aluminum, steel or an alloy, optionally an intermediate reinforcing layer and at least one armor layer comprising metallic strips wound helically about the inner layer. An insulating material such as an aerogel can be furthermore incorporated within such pipeline configurations, for instance between the inner tube and the intermediate reinforcing layer, where thermal insulation is desirable. Incorporating an aerogel material within these structures as the primary insulating material is highly advantages over the aforementioned structures due to the superior insulating qualities of the aerogel. Furthermore, compression resistant aerogels can provide additional compression resistance for the flow line, possibly eliminating additional reinforcing layers while lowering the overall weight of the apparatus without compromising the superior insulating properties.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Moreover, while this invention has been shown and described with references to particular embodiments thereof, those skilled in the art will understand that various other changes in form and details may be made therein without departing from the scope of the invention.

All references cited herein are hereby incorporated by reference in their entireties, whether previously specifically incorporated or not. As used herein, the terms “a”, “an”, and “any” are each intended to include both the singular and plural forms.

Having now fully described this invention, it will be appreciated by those skilled in the art that the same can be performed within a wide range of equivalent parameters, concentrations, and conditions without departing from the spirit and scope of the invention and without undue experimentation.

While this invention has been described in connection with specific embodiments thereof, it will be understood that it is capable of further modifications. This application is intended to cover any variations, uses, or adaptations of the invention following, in general, the principles of the invention and including such departures from the present disclosure as come within known or customary practice within the art to which the invention pertains and as may be applied to the essential features hereinbefore set forth.

1. A method for thermally insulating a flow line comprising:
providing a flow line;
providing an outer carrier pipe that is concentrically aligned with the flow line so as to create an annular space between the flow line and carrier pipe, wherein a spacer is in said annular space;
providing an insulation system comprising an aerogel material, the insulation system substantially filing void volumes outside the spacer in the annular space between the flow line and carrier pipe; and
flowing a fluid through the flow line.

2. The method of claim 1 wherein said aerogel material is compression resistant and capable of withstanding high compressive loads.

3. The method of claim 2 wherein said aerogel material is sealed under a reduced pressure.

4. The method of claim 2 wherein said aerogel material is encased in a membrane, said membrane preventing air or water from entering the aerogel material, while allowing air or water to leave.

6. The method of claim 2 wherein the flow line, carrier pipe, or both comprise a polymer coating for preventing corrosion.

7. A method for thermally insulating a flow line comprising:
providing a flow line;
providing at least one spacer around the flow line;
providing an outer carrier pipe that is concentrically aligned with the flow pipe so as to create an annular space between the flow line and carrier pipe, wherein the spacer is in that annular space;
providing an insulation system that comprises an aerogel material, the insulation system substantially filing void volumes outside the spacer in the annular space between the flow line and carrier pipe; and
flowing a fluid through the flow line.

10. The method of claim 7 wherein said aerogel material is compression resistant.

11. The method of claim 10 wherein said aerogel material is sealed under a reduced pressure.

12. The method of claim 10 wherein said aerogel material is encased in a membrane, said membrane preventing air or water from entering the aerogel material, while allowing air or water to leave.

13. The method of claim 10 further comprising at least one spacer around the flow line, said spacer comprising an aerogel material and sealed under vacuum pressure.

14. The method of claim 10 further comprising at least one spacer around the flow line said spacer being hollow structured and filled with an aerogel material.

15. The method of claim 10 wherein the flow line, carrier pipe, or both comprise a polymer coating for preventing corrosion.

16. A pipe-in-pipe apparatus for thermally insulating a flow line comprising:
a flow line;
a carrier pipe that is concentrically aligned with the flow line so as to create an annular space between the flow line and carrier pipe;
an aerogel material within the annular space between the flow line and the carrier pipe;

17. The apparatus of claim 16 wherein said aerogel material is compression resistant.

18. The apparatus of claim 17 wherein said aerogel material is encased in a membrane, said membrane preventing air or water from entering the aerogel material, while allowing air or water to leave.

19. The apparatus of claim 17 wherein the flow line, carrier pipe, or both comprise a polymer coating for preventing corrosion.

20. A pipe-in-pipe apparatus for thermally insulating a flow line comprising:
a flow line;
at least one spacer;
a carrier pipe that is concentrically aligned with the flow line so as to create an annular space between the flow line and carrier pipe, wherein the spacer is in said annular space; and
an aerogel material within the annular space between the flow line and the carrier pipe, said aerogel material being compression resistant.

21. The apparatus of claim 20 wherein said aerogel material is sealed under reduced pressure.

22. The apparatus of claim 20 wherein said aerogel material is encased in a membrane, said membrane preventing air or water from entering the aerogel material, while allowing air or water to leave.

23. The apparatus of claim 20 wherein said at least one spacer is hollow structured and filled with an aerogel material.

24. The apparatus of claim 20 wherein said at least one spacer is made of an aerogel material and is sealed under vacuum pressure.

25. The apparatus of claim 20 wherein the flow line, carrier pipe, or both comprise a polymer coating for preventing corrosion.

26. A method for thermally insulating a flow line comprising:
providing a flow line;
providing an outer layer such that the overall structure is flexible and an annular space is created between said outer layer and flow line;
providing an aerogel material within said annular space; and
flowing a fluid through the flow line.

27. A pipe-in-pipe apparatus for thermally insulating a flow line comprising:
a flow line;
an outer layer such that the overall structure is flexible an and annular space is created between said outer layer and the flow line; and
an aerogel material positioned within said annular space.
